(19) United States
(12) Patent Application Publication
(10) Pub. No.: US 2018/0215459 A1
(43) Pub. Date: Aug. 2, 2018

(54) DRONE QUADROTOR

(71) Applicants: James S. Busby, JR., Defuniak Springs, FL (US); James S. Busby, III, Defuniak Springs, FL (US); Timothy R. Busby, Defuniak Springs, FL (US)

(72) Inventors: James S. Busby, JR., Defuniak Springs, FL (US); James S. Busby, III, Defuniak Springs, FL (US); Timothy R. Busby, Defuniak Springs, FL (US)

(21) Appl. No.: 15/862,314

(22) Filed: Jan. 4, 2018

Related U.S. Application Data
(60) Provisional application No. 62/442,347, filed on Jan. 4, 2017.

(51) Int. Cl. B64C 1/00; B64C 27/08; B64C 1/06; B64C 1/16

(52) U.S. Cl. CPC B64C 1/0009; B64C 27/08; B64C 1/061; B64C 2001/0072; B64C 2201/024; B64C 2201/108; B64C 2201/042; B64C 1/16

(57) ABSTRACT

Systems and methods that facilitate a quadrotor drone with an improved thrust to weight ratio. The quadrotor drone includes an assembly of vertically oriented arms, i.e., the length and thickness of the arms extend along x and y axes forming faces along the arms generally in an x-y plane and generally facing a direction parallel to an axis of each of the motors, while the width extends along the z axis form forming faces along the arms generally in an x-z and y-z planes and generally facing directions orthogonal to an axis of each of the motors. The arms are preferably formed from a material comprising a continuous fiber from end to end such as, e.g., a carbon fiber material. The arms are mechanically inter-locked at the center of the arms with the longitudinal axes of the arms crossing one another.

### FIELD

The present disclosure generally relates to quadrotor drones and more particularly, to systems and methods that facilitate an improved thrust to weight ratio and a more effective use of thrust as compared to conventional quadrotor drones.

### BACKGROUND

A quadrotor drone, also referred to as a quadcopter or quadrotor helicopter, is a helicopter comprising four rotors used to lift and propel the quadrotor drone. Because their lift is generated by a set of vertically oriented propellers, quadrotor drones are classified as rotorcrafts, as opposed to fixed-wing aircraft.

When used in racing, the design of conventional quadrotor drones tend not to result in the most effective thrust to weight ration and, thus, do not enable the most effective use of thrust.

It is therefore desirable to provide systems and methods that facilitate an improved thrust to weight ratio and a more effective use of thrust as compared to conventional quadrotor drones.

### SUMMARY

The embodiments of the present disclosure are directed to a quadrotor drone and, more particularly, to systems and methods that facilitate an improved thrust to weight ratio and a more effective use of thrust as compared to conventional quadrotor drones. A quadrotor drone in accordance with an exemplary embodiment provided herein includes an assembly of vertically oriented arms, i.e., the length and thickness of the arms extend along x and y axes forming faces along the arms generally in an x-y plane and generally facing a direction parallel to an axis of each of the motors, while the width extends along the z axis form forming faces along the arms generally in an x-z and y-z planes and generally facing directions orthogonal to an axis of each of the motors. This configuration tends to result in a more effective use of thrust, e.g., better prop airflow over arms, material stiffness aligned with thrust vectors and a more stable and responsive quadrotor.

The arms are preferably formed from a material comprising a continuous fiber from end to end such as, e.g., a carbon fiber material. The arms are mechanically inter locked at the center of the arms with the longitudinal axes of the arms crossing one another.

The systems, methods, features and advantages of the example embodiments will be or will become apparent to one with skill in the art upon examination of the following figures and detailed description. It is intended that all such additional methods, features and advantages be included within this description, and be protected by the accompanying claims. It is also intended that the claims are not limited to require the details of the example embodiments.

### BRIEF DESCRIPTION OF FIGURES

The accompanying drawings, which are included as part of the present specification, illustrate the presently preferred embodiment and, together with the general description given above and the detailed description of the preferred embodiment given below, serve to explain and teach the principles of the present invention.

FIG. 1 is a perspective view of an assembled quadrotor drone according to an exemplary embodiment.

FIG. 2 is a perspective view of an exploded assembly of the quadrotor drone embodiment shown in FIG. 1.

It should be noted that the figures are not necessarily drawn to scale and that elements of similar structures or functions are generally represented by like reference numerals for illustrative purposes throughout the figures. It also should be noted that the figures are only intended to facilitate the description of the various embodiments described herein. The figures do not necessarily describe every aspect of the teachings disclosed herein and do not limit the scope of the claims.

### DETAILED DESCRIPTION

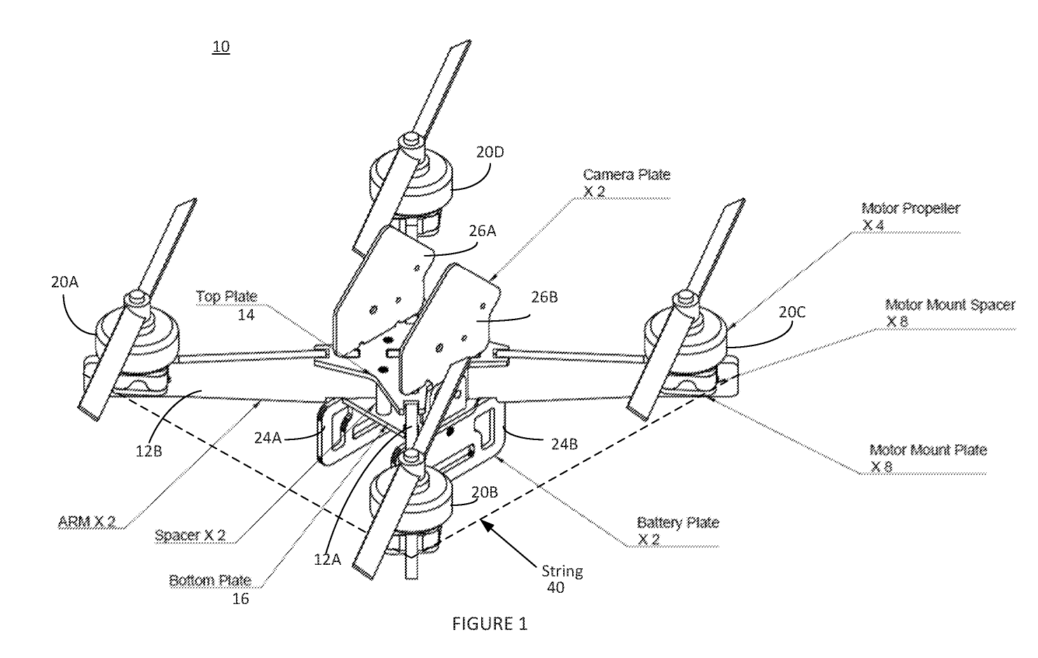

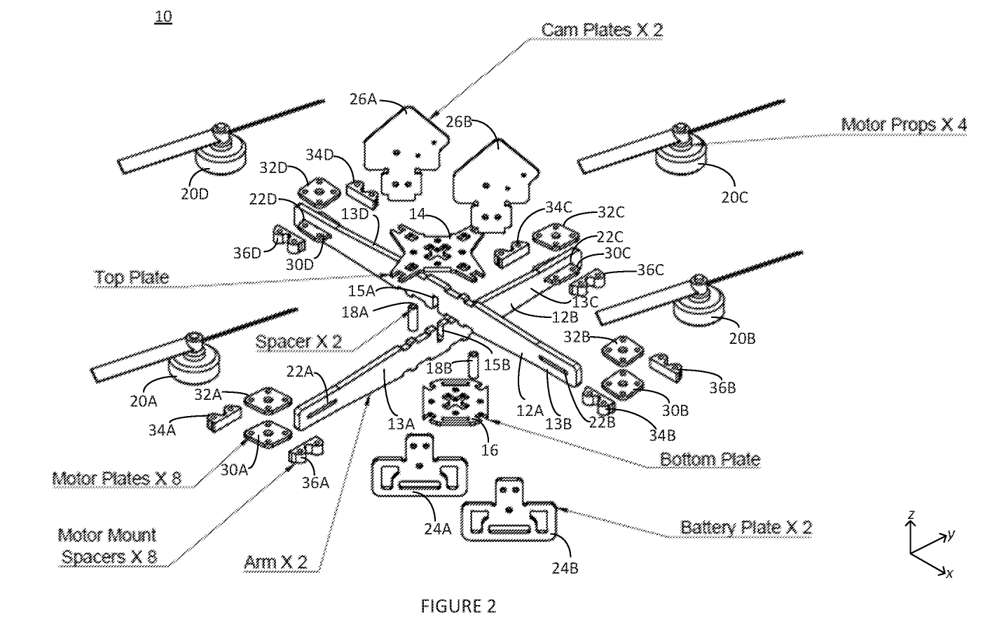

The present embodiments are directed to a quadrotor drone and, more particularly, to systems and methods that facilitate an improved thrust to weight ratio and a more effective use of thrust as compared to conventional quadrotor drones. As shown in FIGS. 1 and 2, a quadrotor drone 10 in accordance with an exemplary embodiment provided herein includes an assembly of vertically oriented arms 12A and 12B, i.e., the length and thickness of the arms extend along x and y axes forming faces along the arms generally in an x-y plane and generally facing a direction parallel to an axis of each of the motors, while the width extends along the z axis form forming faces along the arms generally in x-z and y-z planes and generally facing directions orthogonal to an axis of each of the motors. This configuration tends to result in a more effective use of thrust, e.g., better prop airflow over arms, material stiffness aligned with thrust vectors and a more stable and responsive quadrotor.

The arms 12A and 12B are formed from a material comprising a continuous fiber from end to end such as, e.g., a carbon fiber material. The arms 12A and 12B are mechanically inter locked at the center of the arms 12A and 12B using, e.g., notches 15A and 15B cut into each of the arms 12A and 12B. Top and bottom (upper and lower) plates 14 and 16 also mechanically interlock the arms 12A and 12B using two or more spacers 18A and 18B with four small bolts to constrain the arm assembly. The upper and lower plates 14 and 16 also serve to mount one or more of a flight board and a battery. In addition, a camera could also mount on top of the flight board to provide a fully functioning quadrotor.

Vertically extending side plates 26A and 26B are provided for mounting a camera there between. The side plates 26A and 26B provide more mounting space for the use of different video transmitters that are not integrated into a small camera unit that can be mounted by simply bonding it to the center of the quadrotor arm assembly (arms 12A and 12B and top and bottom plates 14 and 16).

Four motor props 20A, 20B, 20C and 20D are mounted adjacent the outer ends of the arms 12A and 12B using pairs of upper and lower motor mounting plates 30A and 32A, 30B and 32B, 30C and 32C, and 30D and 32D, mechanically interlocked using a pair of spacers 34A and 36A, 34B and 36B, 34C and 36C, and 34D and 36D interposing the pairs of plates and positioned on opposing sides of the arms. The upper plate 32A, 32B, 32C, and 32D, is positioned on top of the arm 12A and 12B while the lower plate 30A, 30B, 30C, and 30D is positioned within the slot 22A, 22B, 22C and 22D cut through the arm 12A and 12B. The motor bolts are on both sides of the arms 12A and 12B, and the plates straddle the arm 30A and 32A, 30B and 32B, 30C and 32C, and 30D and 32D preventing the motor from moving in any direction. Alternatively, a slot is not used and the motor mounting plates are positioned on the top and bottom of the arms 12A and 12B. When the assembly of the plates 30A and 32A, 30B and 32B, 30C and 32C, and 30D and 32D and spacers 34A and 36A, 34B and 36B, 34C and 36C, and 34D and 36D is tightened, the motor prop 20A, 20B, 20C and 20D is secure.

The specifically shaped spacers (i.e., spacers that tend to prevent unwanted movement when the motor bolts compress the plates on the arms) advantageously avoid adding a punitive amount of weight to the quadrotor drone 10.

In another alternative, a string 40 (see FIG. 1), such as, e.g., a Kevlar string, is attached to the four ends of the arms and used to transmit a load to an arm appendage 13A, 13B, 13C and 13D adjacent to an arm appendage 13A, 13B, 13C and 13D that is impacting an object to reduce the chance that either arm appendage 13A, 13B, 13C and 13D will break or deflect beyond the materials ability to return to its original configuration and strength.

The construction of the quadrotor 10 results in a very stiff frame. The exposed and unsupported arm appendages 13A, 13B, 13C and 13D tend not to need the Kevlar string but the addition of the Kevlar string increases structural integrity without a significant weight increase and structural complexity.

In another alternative, an integrated motor mount where the motor would be constructed with the clevis mount as part of the motor. In such a configuration, a single bolt is only required to secure the motor to the arm once it is fitted over the arm and the bolt hole is aligned with the slot. Another benefit of this type of arm style is that the motor can slide in or out to adjust the size of the quad which is not practical to achieve with a flat frame quadrotor drone as it would require slots therefore making the arm even more inefficient.

The vertical oriented arms 12A and 12B, and overall minimal construction tends to reduce the frontal area of the quadrotor drone 10 in the direction of prop airflow over the arms 12A and 12B and the direction the drone 10 tends to travel at its highest speed. The interlocked battery plates 14 and 16 create a more stable constraint for a removable battery which improves performance and weight.

The systems, methods, features and advantages of the invention will be or will become apparent to one with skill in the art upon examination of the figures. It is intended that all such additional methods, features and advantages be included within this description and be within the scope of the invention, and be protected by the accompanying claims. It is also intended that the invention is not limited to require the details of the example embodiments.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

What is claimed:

1. A quadrotor drone comprising
first and second arms coupled to one another in an X formation, the first arm having a longitudinal axis horizontally extending along an x axis and having a thickness extending in a direction parallel to a y axis, the second arm having a longitudinal axis horizontally extending along the y axis and having a thickness extending in a direction parallel to the x axis, the first and second arms having a width vertically extending in a direction parallel to a z axis,
first and second plates opposingly mounted on the top and bottom of the first and second arms and interlocking the first and second arms, and
first, second, third and fourth motor props mounted adjacent the outer ends of the first and second arms.

2. The drone of claim 1 wherein the first and second plates mechanically interlock the first and second arms using two or more spacers to constrain the first and second arm assembly.

3. The drone of claim 1 wherein the first and second arms are formed from a material comprising a continuous fiber from end to end.

4. The drone of claim 1 wherein the first and second are mechanically interlocked at the center of the arms using first and second notches cut into the first and second arms.

5. The drone of claim 1 wherein each of the first, second, third and fourth motor props are coupled to the first and second arms using a pair of upper and lower motor mounting plates.

6. The drone of claim 5 wherein the lower plate is positioned within a slot cut through the first and second arms adjacent the ends.

7. The drone of claim 1 further comprising a structural string is attached to the four ends of the first and second arms to transmit loads between adjacent arms.

8. The drone of claim 7 wherein the structural string is Kevlar.

9. A quadrotor drone comprising
first and second arms coupled to one another and having top and bottom faces, first and second side faces and first and second end faces, wherein the width of the top and bottom faces is less than the width of the first and second side faces,
first and second plates opposingly mounted on the top and bottom of the first and second arms and interlocking the first and second arms, and
first, second, third and fourth motor props mounted adjacent the outer ends of the first and second arms, wherein the top and bottom faces point in a direction parallel to the axes of the first, second, third and fourth motor props.

10. The drone of claim 9 wherein the first and second plates mechanically interlock the first and second arms using two or more spacers to constrain the first and second arm assembly.

11. The drone of claim 9 wherein the first and second arms are formed from a material comprising a continuous fiber from end to end.

12. The drone of claim 9 wherein the first and second are mechanically interlocked at the center of the arms using first and second notches cut into the first and second arms.

13. The drone of claim 9 wherein each of the first, second, third and fourth motor props are coupled to the first and second arms using a pair of upper and lower motor mounting plates.

14. The drone of claim 13 wherein the lower plate is positioned within a slot cut through the first and second arms adjacent the ends.

15. The drone of claim 9 further comprising a structural string is attached to the four ends of the first and second arms to transmit loads between adjacent arms.

16. The drone of claim 15 wherein the structural string is Kevlar.
